(19) United States
(12) Patent Application Publication
(10) Pub. No.: US 2009/0070154 A1
(43) Pub. Date: Mar. 12, 2009

(54) System for funding roadways within a state

(76) Inventor: James A. Herley, Chesapeake, VA (US)

Correspondence Address: GUERRY LEONARD GRUNE, 784 S VILLIER CT., VIRGINIA BEACH, VA, 23452, US

(21) Appl. No.: 12/231,155

(22) Filed: Aug. 29, 2008

Related U.S. Application Data
(60) Provisional application No. 60/993,008, filed on Sep. 7, 2007.

(51) Int. Cl. G06Q 40/00; G06Q 50/00

(52) U.S. Cl. 705/4

(57) ABSTRACT

Disclosed is a method for funding thoroughfares in a state by requiring insurance companies doing business within a state fund a pool of money managed by a fund manager. When a driver is issued pulled over and is issued a summons or has an incident on a roadway the police report the number of emergency vehicles involved at the time and a prescribed fee is released from the pool of money to the designated state department the use of improving roadways. The find manager reports to the insurance company of the driver and the insurance company assesses the fee and a charge to the driver to replenish the pool of money.

### FIELD OF DISCLOSURE

The disclosure relates to funding for new roadways, repairs and maintenance.

### BACKGROUND OF THE DISCLOSURE

Currently there are many methods of obtaining roadway funding. One of the most popular is to create toll roads or to increase tolls and collections on present toll roads. Many states have created the “EZ PASS” system wherein a consumer puts an amount of money into an account that is drawn upon each time the vehicle passes through a toll station. This deposit of money by the consumer goes directly to the state governing agency to be used for roadway funding. An efficiency of the system is that there are lanes that require no toll collectors and each pass through the toll booth is handled electronically, thereby reducing required headcount at the tool booth.

Along with the toll stations, some states are privatizing the management of the toll road collections. This reduces the number of state employees thereby reducing wages and benefits and illustrates the state willingness to contract out for services that are not the main function of the government.

State and local fuel tax revenues are the main staple of roadway funding. Although the tax is placed directly on those who use the roadways the most, it continues to be a dissatisfier during elections. Therefore increasing, or suggestions of increasing, the tax on fuels becomes an unpopular stance during an election year.

Increased state vehicle registration and inspection fees have been suggested. In many states the vehicle inspection is under $20 to ensure the safety of the vehicles, and therefore the vehicles of everyone else on the roadways. Unfortunately, many people do not properly maintain or service theit vehicles and the $20 inspection becomes a $200 repair bill. Consumers would rather consider the $20 inspection was the cause for the $200 repair bill, than cite their own maintenance inadequacies.

Another way to increase road funding is to increase the sales tax on new auto sales. Here is an example of putting the funding burden on people who buy new autos even though those same vehicles are cleaner and over time will produce less emissions than used vehicles that are presently 5 or more years older. These taxes would, by the legislator's decree, be dedicated taxes for roadway building and maintenance.

In Virginia, the legislature mandated an increase of 2.25% in insurance premiums for vehicle owners. This is an example of how the government and insurance companies can work together. Besides the insurance companies are the ones collecting the increased fees, not the state an rightfully so since the insurance companies are better at collecting fees than anyone else. The systems exist for fee collection by the insurance companies. What is unknown is how long does it take from the time of collection until the fee actually reaches the state and is ready for us?

Decreased state employee pensions and benefits were discussed earlier, but how about making sweeping changes throughout the entire government? This is very unpopular within an election year but seems to work well with businesses.

Other proposals include a rural area systems development charge for each mile of proposed housing development for new construction. This would be shared revenue coming from such things as laying water, sewage, gas and electric lines along with constructing the new roadways to gain access to the new developments. A corollary to the rural area systems development charge is a charge for using rural roads and maintaining services to maintain them an/or for emergency services that would use the roads.

When the construction business thought they would be clear of taxation, an aggregate fee for use of natural resources is levied on transportation over 1.5 tons was proposed. Of course this was handled right through the local municipalities in the form of registration fees. And, the corollary to that is the next proposal, the solid waste hauler transportation fee. Put a fee on the garbage hauler and then give them tax incentives or reduced tipping fees in order to pay it.

Assessing a fee rate increase on property taxes at the state an/or local level is another (very unpopular) method of roadway funding. So many funding opportunities go into the property taxes and there is so much intermingling of funds that who knows where the percentages of the taxes are going? Increasing the property taxes does little to increase the value to the senior citizens and those on fixed incomes.

Municipal bonds are another form of raising money guaranteeing that the investor receives a guaranteed interest rate on their invested money. Individuals may have a tough time first obtaining a bond and next filing taxes declaring that the dividend is tax exempt. Problematically, the municipality promises a guaranteed interest rate and is unable to fund the dividends therefore the next municipal bond is floated and the debt just keeps increasing until services and jobs are cut in order to become fiscally sound. Politics aside, both parties do it.

Lastly, lets stick it to the tourists. Here is a popular, albeit somewhat hidden charge on your hotel/motel/B&B bill known as the transient room tax. We hope you enjoyed your stay! Thanks for using our roads to do commerce/vacation here.

Lastly is the funding scheme proposed by the assembly in the State of Virginia. Fees for traffic violations that are collected from Virginia residents only over a three year period wherein a lane change without using a turn signal can net a $900 to the state roadway fund at $300 assessed per year. The drawback, it is only for Virginia drivers ticketed in Virginia. Yes the bill was passed into law and yes it is being forced upon Virginia residents and yes it is being challenged all over the state—doing what—using taxpayer money to defend the legitimacy and civil liberties of the residents of Virginia. Since the enactment of the law, legislators and representatives have been back-pedalling to find a better way to raise the funding needed for roadways. Also, for some, it is an election year and there have been sweeping promises of many voters to remove any incumbent.

Overall, there seems no fair and consistent way to raise finding for roadways that includes charging those who misuse the roads and delay traffic and reward those that are good stewards of the roads safely traveling along and obeying the law. The following disclosure is a method for funding roadways that is fair and consistent and provides a continuing, self-supporting pool of money for roadway.

### OBJECTIVE OF THE DISCLOSURE

Assumptions:
Drivers who appear to have broken a law (traffic or otherwise) may be pulled over to the side of a roadway, interstate, highway, or thoroughfare by law enforcement officers.
Drivers that appear to have broken a law (traffic or otherwise) have exhibited risky behavior in driving or otherwise.
The emergency lighting on law enforcement vehicles cause conscientious drivers to slow down wherever the officer's vehicle is parked.
Slow traffic in an area due to emergency vehicles create traffic tie-ups costing taxpayers and businesses time, associated fuel costs and environmental costs due to wasted fuel and automobile emissions.
Risky drivers are found in all states.
Insurance companies insure good drivers as well as drivers who take risks
Insurance companies are generally risk averse in order to stay in business and the best way to identify risky drivers is to identify risk behavior before incidents (up to and including fatalities) occur.
Insurance companies generally charge higher premiums for drivers that are convicted of traffic infractions.
Insurance companies insure drivers throughout all states.
Insurance companies are generally more proficient at collecting insurance premiums than individual state agencies.

It was reported that in 2006, the Virginia State Police conducted four separate, multi-day operations on Interstates 95 and 81. The enforcement projects resulted in more than 26,000 traffic summonses and arrests being made between the two heavily-traveled corridors. If a set fee, of say $500, were levied upon each of the 26,000 traffic summonses, those two roadways alone would have contributed $13,000,000 ($13MM) toward roadway building and maintenance. Disclosed in the following Summary of the Disclosure is a method to generate funding that includes all violators, including those from different states, that are insured by any insurance company doing business in the state—wherein the individual state is not involved in collections from the violators, but instead is issued violation fees from a funded pool of money that is jointly contributed to by any and all insurance company insuring vehicles within the state.

### SUMMARY OF THE DISCLOSURE

Disclosed is a system for funding thoroughfares in a state wherein the insurance companies doing business within a state fund a pool of money for improving roadways within that state whereby a set fee from the pool of money is managed by a fund manager, and

whereby a vehicle and occupant of the vehicle interacts with a law enforcement officer on a roadway wherein the occupant is exhibiting risky behavior, has incurred an incident or is in violation of any law of that state and wherein a ticket or summons is dispatched from the law enforcement officer to the occupant of the vehicle, and

a report is filed by the law enforcement officer to the law enforcement agency recording a number of emergency vehicles required at the roadway where the vehicle was stopped, the agency reporting the number of emergency vehicles recorded to the fund manager wherein the fund manager releases from the pool of money an amount of the prescribed fee to the state governing body for the use of improving roadways, and

wherein the fund manager reports to the insurance company of the insured vehicle a release of the money from the pool of money wherein the insurance company may assess an owner of the insured vehicle an amount of the prescribed fee and wherein the insurance company transfers an amount equal to the prescribed fee released to the state governing body into the pool of money for replenishment of the pool of money.

An additional embodiment is that the pool of money may be set as a maximum and minimum amount wherein insurance companies may be penalized for a lack of funding of the pool of money and wherein the fund manager manages the pool of money in the prescribed range and reports non-responsive insurance companies to the state governing body.

An additional embodiment is that the insurance company may collect a collection fee from the owner of the vehicle that may be legislated by the state government.

Another embodiment is that the state governing body collects fees only from the fund manager of the pool of money.

Another embodiment is the state legislature legislates the method of communication, the agencies involved, the assessed prescribed fees transferred from the fund manager, the prescribed fees transferred to the fund manager, the method of reporting and archiving, the impact on the insurance companies, the recoverable billing, collection and handling fees allowable to renumerate the insurance companies, the time between law enforcement agency notification and funding release, the time between notification of finding release and insurance company refunding of the pool of money, and other communication or fund transfer issues as they are uncovered.

An additional embodiment is that the prescribed fee assessed to the pool of money and transferred to the state governing body may be correlated to the severity of the incident such as to include each additional emergency vehicle at the roadway.

Another embodiment is that an emergency vehicle may be defined as a law enforcement vehicle, ambulance, fire truck, fire chief, tow vehicle or other vehicle as defined by state law.

Another embodiment is that an incident may be defined a contact with another vehicle, traffic device such as a guard rail, traffic sign, construction device or stationary object on or off the road surface or leaving the road surface in an unsafe manner.

Another embodiment is that the prescribed fee is assessed to reduce traffic slow down and stoppages on roadways, thoroughfares, interstates and highways.

Another embodiment is that the prescribed fee assessed to the pool of money may be based on cell phone usage as a contributing factor in the stoppage by the law enforcement officer, including text messaging.

Another embodiment is that the prescribed fee assessed to the pool of money may be based on cell phone text messaging as a contributing factor in the stoppage by the law enforcement officer.

Another embodiment is that the prescribed fee may be assessed for vehicles exhibiting risky behavior by photographic capture wherein the vehicle is identified as entering an intersection on a red light as captured by a traffic camera.

Another embodiment is that the prescribed fee may be various depending on the type of roadway wherein the prescribed fee may be higher or lower for an interstate versus other roadways.

Another embodiment is that the number of assessed emergency vehicles per stoppage may be recorded in a dispatch office for recordation and transmittal to the fund manager.

Another embodiment is that the fund manager may be a state agency or a business operating within the state.

### DESCRIPTION OF THE DRAWINGS

FIG. 1 is a schematic of the roadway funding disclosure. There are essentially four elements of the disclosed method on how to fund a roadway. The first element is the law enforcement [100], the second element is the insurance company(s) [105], the third is the state roadway agency [110] and the fourth is the fund manager [115].

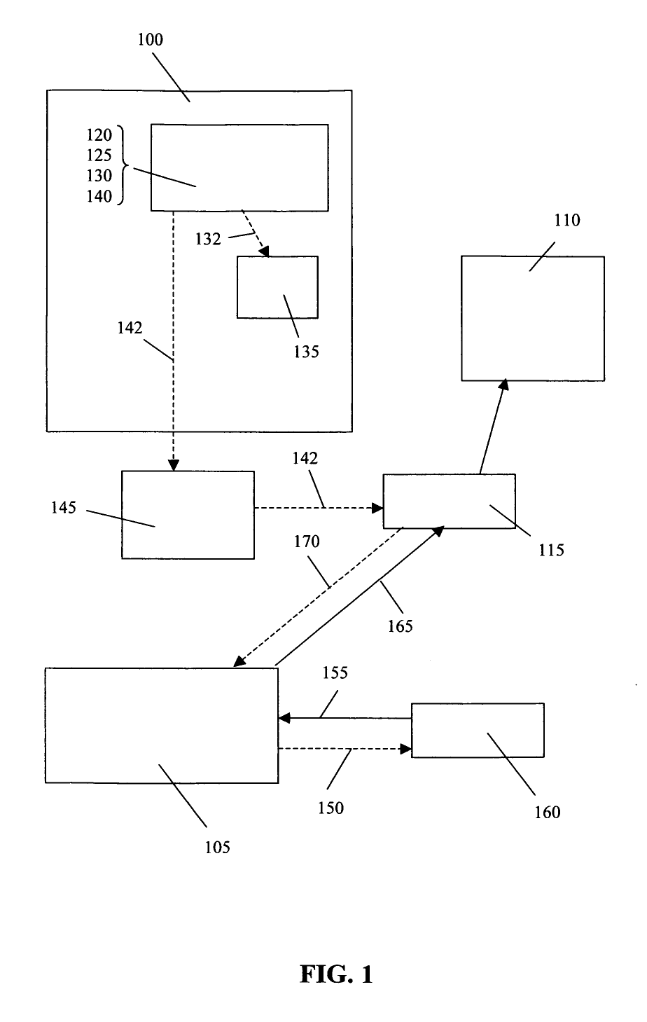

An insured driver [160] is observed exhibiting a risky behavior [120] and is stopped, or pulled over to the side of the roadway or the scene [125] by a law enforcement officer [130]. When the law enforcement officer [130] initiates pursuit, they notify [132] a dispatcher [135] that they are in pursuit of the insured driver [160] exhibiting a risky behavior [120]. The law enforcement officer [130] initiates one or more summonses and the notes the number of emergency vehicles [140] at the scene [125] and reports [142] the information to the law enforcement agency [145]. The insurance company(s) [105] operating in the state, provide a prescribed amount of funding to the fund manager [115] to provide a pool of money. The pool of money is managed by the fund manager [115] and when the fund manager [115] receives a report from the law enforcement agency, or other reporting agency, of the number of emergency vehicles or number of summonses, a prescribed fee is released from the fund manager [115] to the state roadway agency [110] for repairing, maintaining or building roadways. The fund contribution [165] from the insurance company(s) [105] to the fund manager [115] and the prescribed fees released to the state roadway agency [110] for risky driving behavior are legislated [145] by the state government. The fund manager [115] then requests [170] the insurance company(s) to replenish the pool of money in the amount of what was released to the state roadway agency [110] by their insured driver. The pool of money managed by the fund manager [115] therefore should never run to a zero balance and should not fall below a balance to be legislated by the state government [145].

The insurance company(s) [105] are then able to bill [150] and collect [155] the prescribed fee(s) from their insured driver [160] that were released to the fund manager [115] as well as a collection and handling surcharge that is also legislated [145] by the state government.

Advantages to this method are:

The state government does not have to collect fees from insured drivers.

Insurance companies doing business in a given state are better able to bill and collect from their insured, even if the insured resides in another state.

A surcharge legislated to the insurance companies for billing and collecting, ensures that there is a managed profit taking by the insurance company(s).

Insurance companies are better able to identify risky drivers and accordingly charge higher premiums.

This method will also work if a “red light camera” is employed in that the insured of a vehicle gets billed, even if it is a guest driver. This negates the “It wasn't me driving” legal defense.

The method can be phased in by type of roadway (ie: interstate, toll road, 2 lane, etc. . . . ) or by the agency issuing the summons or reporting the number of emergency vehicles.

The fees may be emergency vehicle use fees depending on the number and/or type of emergency vehicles required to resolve the matter at the scene.

The pool of money ensures that roadway funding will continue and is a “pass through” find.

The “fund manager” may be a state agency, insurance company, or privatized.

What is claimed is:

1. A system for funding thoroughfares in a state comprising; insurance companies doing business within a state fund a pool of money for improving roadways within said state whereby a set prescribed fee from said pool of money is managed by a fund manager, and
whereby a vehicle and occupant of said vehicle interacts with a law enforcement officer on a roadway wherein said occupant exhibits risky behavior, incurs an incident or violates any law of said state and wherein a ticket or summons is dispatched from said law enforcement officer to said occupant of said vehicle, and
a report is filed by said law enforcement officer to a law enforcement agency recording a number of emergency vehicles required at said roadway where said vehicle was stopped, said agency reporting said number of emergency vehicles recorded to said fund manager wherein said fund manager releases from said pool of money an amount of said prescribed fee to a state governing body for the use of improving said thoroughfares, and
wherein said fund manager reports to an insurance company of said vehicle a release of said prescribed fee from aid pool of money wherein said insurance company may assess said owner of said vehicle an amount of said prescribed fee and wherein said insurance company transfers an amount equal to said prescribed fee released to said state governing body into said pool of money for replenishment of said pool of money.

2. The system for funding thoroughfares in a state as in claim 1, wherein said pool of money may be set as a maximum and minimum amount wherein said insurance companies may be penalized for a lack of funding of said pool of money and wherein said fund manager manages said pool of money in the prescribed range and reports said insurance companies that are non-responsive to said state governing body.

3. The system for funding thoroughfares in a state as in claim 1, wherein said insurance company may collect a collection fee from said owner of said vehicle that may be legislated by a state government.

4. The system for funding thoroughfares in a state as in claim 1, wherein said state governing body collects said prescribed fees from said fund manager of said pool of money.

5. The system for funding thoroughfares in a state as in claim 1, wherein said prescribed fee assessed to said pool of money and released to said state governing body may be correlated to the severity of the incident such as to include each additional said emergency vehicle at said roadway.

6. The system for funding thoroughfares in a state as in claim 1, wherein said emergency vehicle is defined as a law enforcement vehicle, ambulance, fire truck, fire chief, tow vehicle or other emergency vehicle as defined by state law.

7. The system for funding thoroughfares in a state as in claim 1, wherein said incident is defined as contact with another vehicle, traffic device, traffic sign, construction device or stationary object on or off said roadway or leaving said roadway in an unsafe manner.

8. The system for funding thoroughfares in a state as in claim 1, wherein said prescribed fee is assessed to reduce traffic slow down and stoppages on roadways, thoroughfares, interstates and highways.

9. The system for funding thoroughfares in a state as in claim 1, wherein said prescribed fee assessed to said pool of money may be based on cell phone usage as a contributing factor in said stoppage by said law enforcement officer.

10. The system for funding thoroughfares in a state as in claim 1, wherein said prescribed fee may be assessed for said vehicles exhibiting risky behavior by photographic capture wherein said vehicle is identified as entering an intersection on a red light as captured by said photographic traffic camera.

11. The system for funding thoroughfares in a state as in claim 1, wherein said prescribed fee may be various depending on the type of said roadway wherein said prescribed fee may be higher or lower for an interstate versus other said roadways.

12. The system for funding thoroughfares in a state as in claim 1, wherein said number of emergency vehicles assessed per said stoppage may be recorded in a dispatch office for recordation and transmittal to said fund manager.

13. The system for funding thoroughfares in a state as in claim 1, wherein said fund manager may be a state agency or a business operating within said state.
